(19) United States
(12) Patent Application Publication
(10) Pub. No.: US 2009/0191894 A1
(43) Pub. Date: Jul. 30, 2009

(54) RADIO NETWORK SYSTEM AND METHOD FOR DETERMINING AN UNKNOWN POSITION OF A TRANSMITTING/RECEIVING UNIT OF A RADIO NETWORK

(75) Inventors: Frank POEGEL, Dresden (DE); Dirk Haentzschel, Porschendorf (DE); Peter Dietzsch, Dresden (DE)

Correspondence Address: Muncy, Geissler, Olds & Lowe, PLLC, P.O. BOX 1364, FAIRFAX, VA, 22038-1364, US

(73) Assignee: Atmel Automotive GmbH

(21) Appl. No.: 12/356,987

(22) Filed: Jan. 21, 2009

Related U.S. Application Data
(60) Provisional application No. 61/022,271, filed on Jan. 18, 2008.

(30) Foreign Application Priority Data
Jan. 18, 2008 (DE) 10 2008 005 212.4

(51) Int. Cl. H04W 24/00

(52) U.S. Cl. 455/456.1

(57) ABSTRACT

A method for determining an unknown position of a transmitting/receiving unit of a number of transmitting/receiving units of a radio network, use of a signal quality, and radio network. In the method, a signal field strength and/or a transit time of a signal received through an antenna is measured. A signal quality of the signal received through the antenna is determined. The measured signal field strength and/or the transit time is weighted on the basis of the determined signal quality, wherein the unknown position of the transmitting/receiving unit among the transmitting/receiving units is calculated from multiple weighted signal field strengths and/or transit times and known positions of the transmitting/receiving units.

This nonprovisional application claims priority to German Patent Application No. DE 10 2008 005 212.4, which was filed in Germany on Jan. 18, 2008, and to U.S. Provisional Application No. 61/022,271, which was filed on Jan. 18, 2008, and which are both herein incorporated by reference.

### BACKGROUND OF THE INVENTION

1. Field of the Invention

The present invention concerns a radio network system and a method for determining an unknown position of a transmitting/receiving unit of a radio network, and also concerns the use of a signal quality.

2. Description of the Background Art

Numerous algorithms for determining an unknown position of a node in a sensor network are known from the thesis entitled, “Positionsbestimmung in drahtlosen Ad-hoc-Sensor-Netzwerken,” [position determination in wireless ad hoc sensor networks], Frank Reichenbach, Mar. 31, 2004. Here, the receive signal strength of current transmission technologies is analyzed by merely investigating the measurement of receive signal strength in the form of RSSI values. The RSSI values are measured with three different transmission technologies: ZigBee (IEEE 802.15.4), WLAN (IEEE 802.11), and Bluetooth (IEEE 802.15.1). In the case of ZigBee, the RSSI output voltage is read in and converted to an approximate receive signal strength in units of dBm. In addition to RSSI measurements, Bluetooth has the measurement of a link quality. Link quality is a measure of the reliability of an already opened connection between two nodes. Here, neither signal strength nor link quality provide information on a dependence on distance.

### SUMMARY OF THE INVENTION

It is therefore an object of the invention to provide a maximally improved method for determining an unknown position of a transmitting/receiving unit of a radio network.

Accordingly, a number of a transmitting/receiving units of a radio network are provided, wherein a position of a transmitting/receiving unit among this number is unknown and is to be determined. Each transmitting/receiving unit here is designed to transmit and receive a radio signal through an air interface. In the method, a signal value, such as a signal field strength at the receiver and/or a transit time of a signal received through an antenna, is measured. The measurement here can take place through conversion of an analog voltage corresponding to signal field strength into a digital bit value. Transit time is preferably determined by means of spread sequences. To measure the transit time, the transmitted signal is detected at the receiver, for example by correlation. To this end, a search is preferably performed for the point in time of best agreement—in particular, a peak in the correlation function—of the received signal with expected sequences or symbols. The transit time measurement requires the transmitter and receiver to be synchronized after a fashion, which is to say to have identical time bases, in order to calculate the time difference between transmission and reception.

A signal quality of the signal received through the antenna is also determined in the method. The quality of the signal is preferably derived from the average correlation value of multiple symbols of the signal. If the received power is less than a receiver sensitivity, the quality may depend on the signal field strength.

The signal quality can be determined from a ratio of transmitted data frames or data packets with errors in transmission to a total number of transmitted data frames or data packets. In addition, the number of erroneous symbols in each data frame or data packet can be evaluated to determine the signal quality.

Moreover, the measured signal field strength and/or the transit time are weighted on the basis of the determined signal quality. In this context, weighting is understood to mean that the signal field strength and/or the transit time and the signal quality associated with the signal field strength and/or the transit time are evaluated together in the subsequent calculation. The signal quality here indicates the reliability and probability of error of the measured signal field strength using the models used. It is preferably provided here that the signal quality is determined from the same signal scope as the signal field strength and/or the transit time [are determined from], so that the signal field strength and/or the transit time and the respective signal quality have a fixed association with one another. Preferably, the signal field strength and/or transit time as well as the signal quality are determined for the same at least one data frame or data packet. This measurement can advantageously be repeated with multiple data frames in order to reduce, e.g., time-variant measurement errors.

Moreover, in the method the unknown position of the transmitting/receiving unit is calculated from multiple weighted signal field strengths and known positions of other transmitting/receiving units from among the number. It is not necessary here for all positions of the other transmitting/receiving units to be known.

Another aspect of the invention is a radio network system with a number of transmitting/receiving units. Each transmitting/receiving unit of the radio network system has measurement means that are set up to measure a signal field strength and/or a transit time of a signal received through an antenna. Moreover, the measurement means are set up to determine a signal quality of the signal received through the antenna. Preferably, in a spread spectrum system the signal quality can be determined through correlation of the demodulated received signal with known or expected sequences. To this end, a detector is preferably provided. The detector can advantageously be set up with a dual function for detecting the data.

The radio network system has calculating means that are set up to calculate an unknown position of a transmitting/receiving unit. The calculating means may be embodied inside the receiving unit with the unknown position, for example. Alternatively, the calculating means are embodied in a central computer of the radio network system that is designed to calculate a plurality of unknown positions of transmitting/receiving units within the radio network system. To this end, multiple measured signal field strengths and/or transit times and signal qualities that have been determined by a given transmitting/receiving unit are transmitted to the central computer in the form of data.

The unknown position of the transmitting/receiving unit is calculated from measured signal field strengths and/or transit times of received signals and known positions of the transmitting/receiving units.

The calculating means are set up for weighting of the measured signal field strength and/or the transit time using the signal quality determined. The weighting here constitutes a functional relationship, wherein a measured signal field strength and/or the measured transit time with an associated higher signal quality is given a higher weight than a measured signal field strength and/or the measured transit time with a lower signal quality. The weighting can be expressed by a factor in the range from 0 to 1, for example.

Another aspect of the invention is the use of a signal quality for weighting a measured signal field strength and/or a measured transit time.

Accordingly, a signal quality is determined from a transmitted data frame. Such a data frame is a specific or variable sequence of bit values that are transmitted as a signal by means of a modulation. The signal quality is used to weight a measured signal field strength and/or a transit time, wherein the signal field strength and/or the transit time are measured by a signal received through an antenna.

An unknown position of a transmitting/receiving unit of the radio network having a number of transmitting/receiving units is calculated from multiple weighted signal field strengths of multiple received signals and known positions of the transmitting/receiving units.

The further developments described below relate to the method for determining an unknown position, and also to the radio network system with the number of transmitting/receiving units, and also to the use of a signal quality for weighting a measured signal field strength and/or a measured transit time.

According to an embodiment, provision is made that a weighting factor is assigned to a value range of the signal quality. For example, if the signal quality is specified between 0% and 100%, the weighting factor 0.25 can be assigned to the value range between 0% and 25%, the weighting factor 0.5 can be assigned to the value range between 26% and 50%, the weighting factor 0.75 can be assigned to the value range between 51% and 75%, and the weighting factor 1 can be assigned to the value range between 76% and 100%. Alternatively, it is possible to assign the weighting factor 0 to the value range between 0% and 50%, and the weighting factor 1 to the range between 51% and 100%.

It is also possible to change the value range and/or weighting factor during the method. It is also possible that the weighting factor is calculated from values in the value range based on a predetermined function. Preferably, the weighting factor is produced by means of a predetermined function of the signal quality. In an especially advantageous variant further development, provision is made that two value ranges of the signal quality are distinguished by a threshold. For example, the threshold here can be a threshold value that compares the signal quality with the threshold value in the manner of a comparator function. Alternatively, the threshold can also be variable, based on the number of measurement results, for example. A fuzzy logic unit can also be used as an alternative to a threshold.

In another embodiment, a first value range of the two value ranges can be assigned the weighting factor 0 and a second value range of the two value ranges is assigned the weighting factor 1. Measured field strengths that are weighted with the weighting factor 0 drop out of the calculation of the unknown position and are not taken into account.

According to a further embodiment, a subset of transmitting/receiving units out of the number of transmitting/receiving units can be identified by the weighting of the signal field strengths and/or the transit times. Here, the unknown position is determined exclusively using the signal field strengths and/or the transit times of the transmitting/receiving units in this subset. In one embodiment, the number of transmitting/receiving units in this subset can be fixed and predetermined. Alternatively, the number of transmitting/receiving units in this subset is determined by comparing the signal quality with a reference value.

In another embodiment, which can of course also be combined with the foregoing further developments and embodiments, a subgroup of transmitting/receiving units out of the number of transmitting/receiving units are identified by evaluation of the measured signal field strengths and/or the transit times. The unknown position is calculated here on the basis of the measured signal field strengths and/or on the basis of the transit times of the transmitting/receiving units of this subgroup. The subgroup here is preferably limited to a maximum number of measured signal field strengths and/or measured transit times. Alternatively, the number of transmitting/receiving units can be determined by a comparison of the signal field strengths and/or transit times of the received signals with a reference value.

According to an embodiment, a signal is repeatedly transmitted for measuring the signal field strength and/or the transit time and for determining the signal quality when the signal quality falls below a threshold value and/or the transit time exceeds a threshold value. Preferably, the repetition of transmission is terminated once a termination criteria, for example a specific number of repetitions, is reached.

The Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a radio network system, and

FIG. 2 is a schematic process sequence.

### DETAILED DESCRIPTION

Future radio systems should permit position determination of transmitters and/or receivers in addition to the transmission of data. These systems are equipped with special structures and/or protocols to permit position determination with an accuracy of a few meters or fractions of a meter. These can be suitable spreading sequences, for example, which permit precise determination of the transit time of the radio waves and thus of distance. One standard in this context is IEEE 802.15.4a.

Determination of position or distance is possible based on information about a relative signal field strength of a received radio signal, for example. For example, information on the relative signal field strength of the received radio signal can be converted into a relative distance. If one assumes free-space propagation between transmitter and receiver, then 6 dB of difference in the received power mean a halving or doubling of the distance. If one knows the precise position of some transmitters/receivers, then the position of other transmitters/receivers can be determined therefrom under the assumption of free-space propagation. If this assumption is not valid, i.e. if there is significant multipath propagation, then the results are inaccurate or totally unusable.

Disclosed in the following exemplary embodiments are a radio network and a method that includes at least one piece of quality information regarding the received signal (LQI—Link Quality Indicator) in the evaluation by means of weighting in addition to the received signal field strength (RSSI—Received Signal Strength Indicator). A weighting of the reliability of the signal field strength for a position or distance determination can be undertaken as a function of the quality information. Poor quality of the received signal indicates strong multipath propagation, so that the assumption of free-space propagation is not valid. High quality, in contrast, confirms the assumption of free-space propagation, and the value of the received power is well suited for use in further calculations. Interference from interference sources (microwaves, etc.) can also limit the use of signal field strength for position or distance determination, although this is also reflected in the quality information.

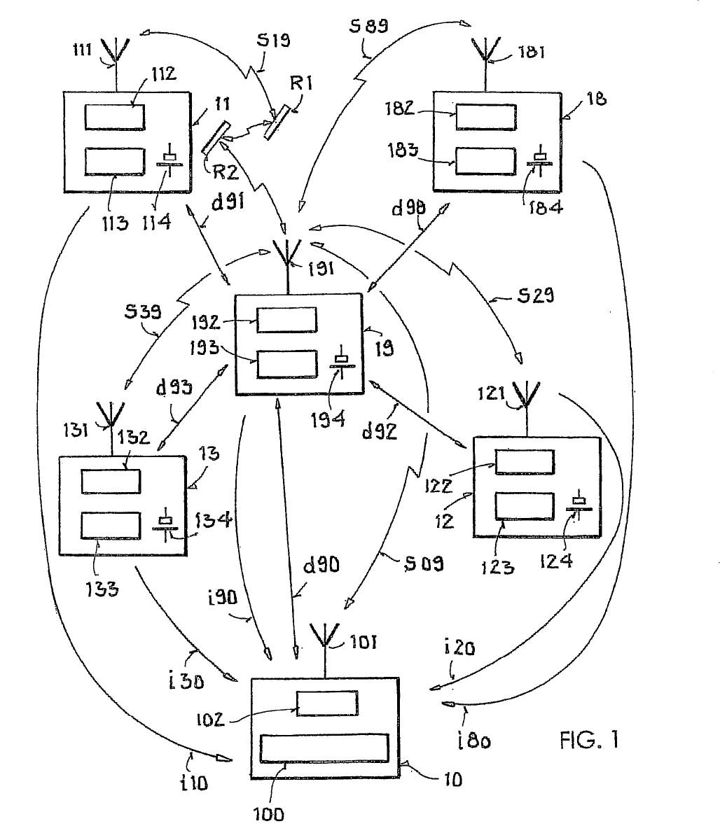

FIG. 1 shows a radio network system with a number of transmitting/receiving units 11, 12, 13, 18, 19 and with a central transmitting/receiving unit 10. Here, the central transmitting/receiving unit has an antenna 101 and a transceiver 102 connected to the antenna 101. The transceiver is connected to a computing unit 100. The central transmitting/receiving unit 10 in the exemplary embodiment in FIG. 10 is powered by an external power source (not shown in FIG. 1).

The first transmitting/receiving unit 11 has an antenna 111 on the transceiver 112 and has a computing unit 113, for example a microcontroller. The transceiver 112 and computing unit 113 are powered by a battery 114 as their power source. Moreover, the transmitting/receiving unit 11 can have additional elements, such as a sensor or an actuator, for example.

The transmitting/receiving unit 12 is also constructed in similar fashion, also having an antenna 121, a transceiver 122, a computing unit 123, and a battery 124. A third transmitting/receiving unit 13 is also provided, which also has an antenna 131, a transceiver 132, a computing unit 133, and a battery 134.

The fourth computing unit [sic] 18 likewise has an antenna 181, a transceiver 182, a computing unit 183, and a battery 184. The fifth transmitting/receiving unit 19 likewise has an antenna 191, a transceiver 192, a computing unit 193, and a battery 194. In the exemplary embodiment from FIG. 1, the position of the transmitting/receiving units 11, 12 and 13 within the radio network is known. Also known is the position of the central transmitting/receiving unit 10. The positions of the transmitting/receiving units 18 and 19 are unknown.

The position of the (fifth) transmitting/receiving unit 19 is now to be determined in the exemplary embodiment from FIG. 1. In a first variant embodiment, the transmitting/receiving unit 19 receives a first signal S19 from the first transmitting/receiving unit 11. From the received signal S19, the transmitting/receiving unit 19 measures a first signal field strength and a first signal quality associated with this signal field strength. In addition, a signal S29 is transmitted from the second transmitting/receiving unit 12 to the fifth transmitting/receiving unit 19 having the unknown position. The fifth transmitting/receiving unit 19 receives the signal S29 and in turn measures a second received signal field strength and an associated second signal quality.

A third signal S39 is transmitted from the third transmitting/receiving unit 13 to the fifth transmitting/receiving unit 19. In turn, the fifth transmitting/receiving unit receives the signal S39 through its antenna 191 and measures the received third signal field strength and associated third signal quality using measurement means of the transceiver 192. Moreover, the fifth transmitting/receiving unit 19 can receive an additional signal S09 from the central transmitting/receiving unit 10 and can also determine an additional signal field strength and an additional signal quality accordingly.

The fifth transmitting/receiving unit 19 autonomously determines its position in the radio network system from the measured signal field strengths and signal qualities. To this end, the fifth transmitting/receiving unit 19 has computing unit 193, which processes the values of the signal field strengths and signal qualities with an algorithm.

In like manner, an additional variant exemplary embodiment is shown in FIG. 1, wherein the signal S89 is additionally transmitted between the fourth transmitting/receiving unit 18 and the fifth transmitting/receiving unit 19. It is likewise possible for the signals S19, S29, S39, S09 and S89 to be sent, received, and transmitted bidirectionally, which is to say by the fifth transmitting/receiving unit 19 in each case. During this process, the other transmitting/receiving units 10, 11, 12, 13 and 18 also determine the signal field strengths and signal qualities of each of the signals S19, S29, S39, S09 and S89 received there. The data concerning the measured signal field strengths and signal qualities are transmitted in the form of information from the respective transmitting/receiving unit 11, 12, 13, 18 and 19 to the central transmitting/receiving unit 10 as information i10, i20, i30, i80, and i90. In this case, the central transmitting/receiving unit 10 calculates the distances between all transmitting/receiving units 10, 11, 12, 13, 18 and 19 from this information i10, i20, i30, i80, and i90 as distances d91, d92, d93, d90, and d98.

The transmitting/receiving units 10, 11, 12, 13, 18 and 19 communicate in the high frequency or ultra-high frequency range of the electromagnetic spectrum (radio frequency (RF) range). In the case of an ideal channel, which is to say a channel with no interfering influences of any sort, the attenuation and time delay of the transmitted signal are determined by the distance through the channel. The attenuation between transmitter and receiver is defined as the ratio between transmitted and received power. If one assumes ideal free-space propagation about a transmitter 11, 12, 13, 18 or 19, the channel attenuation can be described as a function of the transmitter/receiver distance d90, d92, d93, or d98. In practice, however, a transmitted signal is degraded by obstacles R1, R2 in space through multiple effects.

When a radio wave S19 strikes a flat surface, it is partially reflected, which is to say with reduced power, at these reflectors R1, R2. The exit angle of the reflection here corresponds to the angle of incidence of the reflected signal. At rough surfaces, the power of the reflection is distributed among multiple components with different exit angles. At edges of objects in space, the direction of propagation of the wave is altered by diffraction. The absorption effect also arises, in which transmission of a wave through materials reduces the amplitude of the transmitted wave. In real radio network systems, multiple components of the transmitted signal S19 having different attenuation and delay are superimposed at the receiver 19 as a result of reflection, scattering, and diffraction. This can also be referred to as multipath propagation.

For example, if two components of a signal are superimposed, this can result in a maximum intensification in an extreme case with positive superposition. In contrast, however, when two components of opposite phase are superimposed, a minimal signal amplitude results. In reality, an infinitely large number of reflected components with random attenuation and delay are superimposed at the receiver. The channel can then be assumed to be a complex Gaussian process. If the received signal consists of only reflected components, its random amplitude has a Rayleigh distribution. If, in addition, a direct signal between the transmitter and receiver is present that has not been reflected, then the amplitude at the receiver is subject to a Rice distribution.

As in the case of a deterministic propagation through two paths, the amplitude at the receiver is a function of the frequency of the transmitted wave, since the constellation of received phases changes when the frequency is changed. In like manner, massive changes in the amplitude can be produced by very small changes in the position of the transmitter or receiver 10, 11, 12, 13, 18 or 19.

Absorption effects result in an additional change in the received signal field strength in comparison to the ideal attenuation of the channel. In a generalized manner, the real attenuation increases with the so-called attenuation coefficient over the transmitter/receiver distance d90, d91, d92, d93, d98.

For many applications in radio networks, it is necessary to know the relationship between the acquired data and their source. For example, if transmitting/receiving units 11, 12, 13, 18 or 19 of an agricultural field monitored by a radio network report a nutrient deficiency in the soil, this information is virtually worthless if the location of this information is not identified. While it is possible in the case of permanently installed networks to determine the position of each node at its installation and store it in a database, at an increased setup cost for the network, this procedure cannot be realized for many other scenarios. For example, if sensor nodes as transmitting/receiving units 11, 12, 13, 18 and 19 are dropped over a forest for purposes of fire prevention, the position of only a few transmitting/receiving units 10 is known, for example with an integrated GPS module. In contrast, the majority of the other transmitting/receiving units (11, 12, 13, 18 and 19) are initially unknown.

The measurement of the attenuation of transmitted signals by the transmission channel, the transit time of the signal, and/or the measurement of the phase of a transmitted wave are suitable as basic physical metrics for determining the position. These basic quantities can then either be used directly as input data for position determination, or can be transformed for other positioning steps into abstract quantities, such as, e.g., distances, angles for geometric algorithms, or connectivity for coarse-grained applications.

Every real transmission channel attenuates the power of signals S19, S29, S39, S09 and S89 transmitted through it on the way from the transmitter to the receiver 11, 12, 13, 18, 19 and 10. The power of the attenuated signal S19, S29, S39, S09 and S89 can be determined at the receiver in the form of a signal field strength. An RF receiver 11, 12, 13, 18, 19 has a measurement circuit 112, 122, 132, 182 or 192 to determine the signal field strength and to dynamically adjust the amplitude of the received signal S19, S29, S39, S09 and S89 for further processing in a synergistic manner (Automatic Gain Control, AGC).

The signal field strength received by a reference station 11, 12 or 13 can be used as a direct measure of a position. For position determination, the measured signal field strength is then compared with a reference database in order to assign it a position. Another possibility, in the case of known attenuation function of the channel and known output power of the transmitter 11, 12, 13, is to map the received signal field strength to a transmitter/receiver distance d91, d92, or d93. In order to transform the signal field strength into distance, various propagation models can be used for the received signal field strength. In addition, the receiver could have an antenna array whose individual components have a directional characteristic. Using measured signal field strength differences, the angle of incidence of the received signal S19, S29, or S39 can be reconstructed by means of the directional characteristic. However, this is not strictly necessary in the case of a plurality of transmitting/receiving units 11, 12, 13, 18, 19 and 10.

Different positioning methods can be used to determine the unknown position. For an exact geometric method, the axioms of elementary geometry are used in order to determine the unknown position of the newly added transmitting/receiving unit 19 (or 18) based on metrics such as distances or angles relative to known positions of the other transmitting/receiving units 11, 12 or 13. Examples of this include the fine-grained models lateration, angulation, and RIPS. In exchange for their simplicity and low resource requirements, approximation methods permit systematic errors in position determination and thus only a limited accuracy and rough precision. Another positioning model is scene analysis, in which the finding of an unknown position is accomplished by recognition of a measured pattern in a database.

In the lateration method, distance measurements between a known node of a transmitting/receiving unit 11, 12, 13 and an unknown node of a transmitting/receiving unit 19 are used to determine the position of the unknown transmitting/receiving unit 19. The fundamental approach here is atomic lateration, in which only distances d91, d92, d93, d90, d98 between a transmitting/receiving unit 19 of unknown position and multiple transmitting/receiving units 11, 12, 13 with known positions are used. Atomic lateration can be extended through an iterative process. In collaborative lateration, distances d98 between transmitting/receiving units 18 and 19 are also used, where these two transmitting/receiving units 18 and 19 have unknown positions. This distance d98 is used to determine the position with respect to the entire radio network of all transmitting/receiving units 18, 19 having unknown positions.

With the principle of lateration, the object is to determine the unknown position of a transmitting/receiving unit 19 in such a manner that all determined distances d91, d92, d93 and d90 from the positions of the receiving units 10, 11, 12, and 13 serving as reference apply to this determined point. The respective distance d90, d91, d92 and d93 between unknown positions of the transmitting/receiving unit 19 and the position of a respective transmitting/receiving unit 10, 11, 12 or 13 as reference can be specified as the Euclidian distance of their Cartesian position vectors. Instead of the exact measured distances, the distances d90, d91, d92 and d93 also differ by a measurement error. The probability of measurement errors is a function of the probability density of the measurement error process in a transmitter/receiver distance.

In the exemplary embodiment in FIG. 1, all distances d90, d91, d92 and d93 to the transmitting/receiving units 10, 11, 12 and 13 as references are determined with the same measurement method. This results in a system of equations with a solution set. The number of independent linear equations here is larger than the dimensionality of the position vectors, which is to say that if at least three non-collinear or four non-coplanar reference positions exist in the plane for localization in space, then the system has exactly one analytically determinable solution.

In the exemplary embodiment in FIG. 1, however, the measurement error is unknown and the point in the search space that minimizes the error vector must be determined by a regression method. This can be formulated as a maximum likelihood optimization problem.

In a radio network, multiple transmitting/receiving units 18, 19 with unknown positions are typically present. In an extension of atomic lateration, each transmitting/receiving unit 18, 19 with an unknown position is used, after its position has been determined, as an additional reference for each remaining transmitting/receiving unit 18, 19 with another unknown position. The newly determined position of a new reference here is in general subject to error. In iterative lateration, the localization of each transmitting/receiving unit with an unknown position is repeated with the aid of newly obtained references until a termination condition is satisfied. Such a termination condition is an adequately converged position, for example.

Collaborative lateration also uses the information determined by measurement of the signal field strength and signal quality of a signal S89 transmitted between two transmitting/receiving units 18, 19 with unknown positions. The collaborative approach of lateration is to achieve localization of all transmitting/receiving units 19 etc. with unknown positions in the network in parallel as a global optimization problem. In the exemplary embodiment in FIG. 1, this global optimization problem is solved in the central transmitting/receiving unit 10 by means of a computing unit 100 in which a suitable algorithm is implemented.

In place of the signal field strength, a transit time of the signal can also be used for distance determination in the exemplary embodiment from FIG. 1. If information concerning both signal field strength and transit time is available, a combined evaluation of the signal field strength and the transit time is advantageous for determining the distance. For example, the transit time measurement can be verified by means of the measurement of the signal field strength.

The radio wave of the signal S19, which is transmitted between the first transmitting/receiving unit 11 and the fifth transmitting/receiving unit 19, is reflected and attenuated at the two reflectors R1 and R2—a building or the like, for example. Because of the above-described characteristics of the transmission channel, the signal quality can be significantly degraded by reflection at the reflectors R1 and R2. If a degradation in signal quality is determined by the transmitting/receiving unit 19, this information is used for weighting the signal field strength and/or the transit time. In the exemplary embodiment from FIG. 1, the distance between the first transmitting/receiving unit 11 and the fifth transmitting/receiving unit 19 can be left out of the calculation of the position of the fifth transmitting/receiving unit 19 as a result of the weighting.

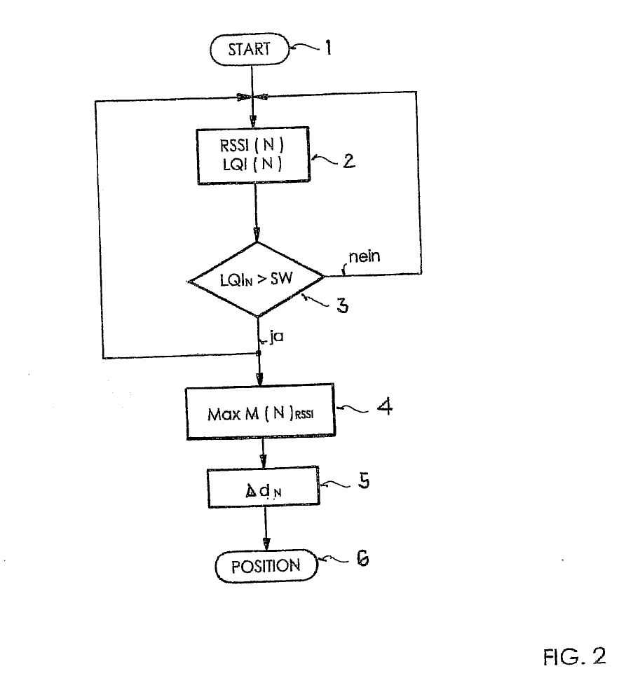

By way of example, FIG. 2 shows a process sequence in the form of a schematic flow diagram. The process is started in step 1. For example, the start can be initialized by the turning on of a new transmitting/receiving unit 19 with unknown position in that this transmitting/receiving unit 19 begins to transmit or receive signals S09, S19, S29, S39 or S89 to or from surrounding transmitting/receiving units 11, 12, 13, 18 or 10. In the exemplary embodiment in FIG. 2, a number N of transmitting/receiving units are within transmission range of the new transmitting/receiving unit 19 with unknown position. In the second step, a signal field strength RSSI and a signal quality LQI are measured or determined for each of the N transmitting/receiving units 11, 12, 13, 18, 10.

In the following third step 3, the Nth signal quality LQI(N) associated with a particular transmitting/receiving unit is compared with a threshold value SW for the corresponding transmitting/receiving unit 11, 12, 13, 10 or 18. If the determined signal quality LQI(N) is less than the threshold value SW, the signal field strength RSSI is weighted with the factor 0 in step 3 and, in a repetition of step 2, the signal field strength RSSI and the signal quality LQI for another transmitting/receiving unit are measured and the additional signal quality LQI is compared with the threshold SW once again in the following step 3. If the signal quality LQI(N) is greater than the threshold value, then the signal field strength RSSI is weighted with the factor 1 in step 3 and steps 2 and 3 are repeated for the remaining transmitting/receiving units 11, 12, 13, 18, 10.

If the signal quality LQI(N) is less than the threshold value SW, the signal field strength RSSI is initially weighted with the factor 0. In another embodiment, it is possible in this case to repeat the transmission of the signal to or from the associated base transmitting/receiving unit.

Once the signals of all transmitting/receiving units 11, 12, 13, 18 and 10 in range are measured and the values of the signal field strengths RSSI are weighted, another subgroup is determined from among the signal field strengths of a subset having weighting 1 by the means that a number M of signal field strength measurements is determined in step 4. This subgroup determines, for example, the five transmitting/receiving units with the greatest signal field strengths in step 4.

As an alternative to the exemplary embodiment shown in FIG. 2, the determination of the subgroup can also take place, using the measured signal field strengths, before the weighting of the signal field strengths, and thus before the formation of the subset using this weighting.

In step 5, the distances Δd_{N}, in other words d90, d91, d92, d93 and d98, are determined. Determination of the position takes place in step 5 using the lateration principle based on the signal field strength. In order to map the received signal field strengths to the distance, the parameters of a propagation model for the received signal field strength must be determined here a priori. The search for references among transmitting/receiving units 11, 12, 13, 10 with known positions then follows. The subsequent aggregation of the measured data also takes place in step 5. In addition, the measured data are optimized in step 5. To this end, a filtered, scalar signal field strength is generated as an input quantity for each transmitting/receiving unit 11, 12, 13, 10 with known position. In the last part of step 5, a solution for the unknown position is sought. The geometrically exact approach to searching for the location of an optimum error vector is the solution of a maximum likelihood problem. The determined position is subsequently placed in a memory and stored in step 6.

In the exemplary embodiment from FIG. 2, a transit time of the signal can be used for distance determination in place of the signal field strength. If information concerning both the signal field strength and the transit time is available, a combined evaluation of the signal field strength and the transit time is advantageous for determining the distance. For example, the signal field strength can be verified by means of the transit time measurement.

The invention is not restricted to the variant embodiments shown in FIGS. 1 and 2. For example, it is possible to provide a significantly larger number of transmitting/receiving units in the transmission range. It is also possible to use other methods for determining the position, which use signal field strengths and/or transit times and signal qualities as input quantities. The functionality of the radio network system of the exemplary embodiment from FIG. 1 can be used to particular advantage for a wireless ad hoc sensor network.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A method for determining an unknown position of a transmitting/receiving unit from a plurality of transmitting/receiving units of a radio network, the method comprising:
measuring a value of a signal that is received through an antenna;
determining a signal quality of the signal received through the antenna;
weighting the measured value based on the determined signal quality; and
calculating the unknown position of the transmitting/receiving unit among the transmitting/receiving units from multiple weighted values and known positions of the transmitting/receiving units.

2. The method according to claim 1, wherein the measured value is a signal field strength and/or a transit time and/or a phase shift.

3. The method according to claim 1, wherein a weighting factor is assigned to a value range of the signal quality.

4. The method according to claim 3, wherein two value ranges of the signal quality are distinguished by a threshold.

5. The method according to claim 4, wherein a first value range of the two value ranges is assigned the weighting factor zero and a second value range of the two value ranges is assigned the weighting factor one.

6. The method according to claim 2, wherein a subset of transmitting/receiving units, out of the number of transmitting/receiving units, are identified by the weighting of the signal field strengths and/or transit times, and the unknown position is calculated on the basis of the signal field strengths and/or transit times of the transmitting/receiving units of this subset.

7. The method according to claim 2, wherein a subgroup of transmitting/receiving units, out of the number of transmitting/receiving units, are identified by evaluation of the measured signal field strengths and/or transit times, and the unknown position is calculated on the basis of the measured signal field strengths and/or transit times of the transmitting/receiving units of this subgroup.

8. The method according to claim 2, wherein a signal is repeatedly transmitted for measuring the signal field strength and/or transit time and for determining the signal quality when the signal quality falls below a threshold value.

9. A radio network system having a plurality of transmitting/receiving units, the network system comprising:
a measurement component provided in at least one of the transmitting/receiving units, which are configured to measure a signal field strength and/or a transit time of a signal received through an antenna and are configured to determine a signal quality of the signal received through an antenna;
calculating component configured to calculate an unknown position of a transmitting/receiving unit from the plurality of transmitting/receiving units from measured signal field strengths and/or transit times of received signals and known positions of the transmitting/receiving units, the calculating component configured to weight the measured signal field strengths and/or transit times using the signal quality that has been determined.

10. Use of a signal quality determined from a transmitted data frame for weighting a measured signal field strength and/or a measured transit time of a signal received through an antenna, wherein an unknown position of a transmitting/receiving unit in a radio network having a number of transmitting/receiving units is calculated from multiple weighted signal field strengths (RSSI) and/or transit times of multiple received signals and known positions of the transmitting/receiving units.
